(19) United States
(12) Patent Application Publication
(10) Pub. No.: US 2003/0138292 A1
(43) Pub. Date: Jul. 24, 2003

(54) Hub with increased torque transfer capability

(76) Inventor: Paul Webb Zeng, Mentor, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/054,278

(22) Filed: Jan. 22, 2002

(51) Int. Cl. B25G 3/02

(52) U.S. Cl. 403/362

(57) ABSTRACT

A hub for securing a shaft that provides three or more points of contact with a motor shaft. The hub of the present invention comprises a body having at least one bore into which the shaft is inserted and a groove in the wall defining the bore positioned generally opposite a set screw hole to provide at least two points of contact with the shaft, thereby providing at least three points of contact to secure the shaft inside the bore: one point of contact between the set screw and the shaft and the other two points of contact between the shaft and the body on either side of the groove. The present invention also includes various impellers using the hub of the present invention, such as a “squirrel cage” impeller with the hub of the present invention, and other classic hub applications with the hub of the present invention, such as a gear plate or a pulley using the hub of the present invention.

### FIELD OF THE INVENTION

The present invention relates generally to improved attachment of a hub to a shaft, such as improved attachment of an impeller hub to a motor-driven shaft, and more specifically to a hub that provides three points of contact with the shaft.

### BACKGROUND

One common system used to circulate air or other fluids includes a motor that rotates a shaft to which an impeller is attached. This system can employ a wide variety of motors and impeller configurations, as well as any of several means of attaching the impeller to the shaft. Commonly, a set of blades is attached to a base plate, which can take the form of, e.g., a center plate (shown in FIG. 1) or a spider (shown in FIG. 2). One typical way to attach the base plate to the shaft is with a hub. The hub can be a separate piece attached to the base plate or can be made as an integral part of the base plate or even an integral part of the entire impeller.

An exemplary center plate fan assembly, known as a wheel-type impeller or a “squirrel cage” impeller, is shown in FIG. 1. In this type of fan assembly, the individual blades are usually evenly spaced around and connected to the outer edge of the center plate and are aligned parallel to the center axis of the center plate. Each of the blades is curved and/or slightly angled approximately the same amount (relative to a tangent to the circular center plate) to produce the desired circulation as the shaft turns the center plate and the blades. Support rims can be added to connect the ends of the blades together, and thereby increase the rigidity of the blades. An air circulation mechanism of this type is often employed in furnaces, air conditioners and a wide variety of other HVAC equipment.

An exemplary spider configuration is shown in FIG. 2 and consists of a plurality of evenly proportioned arms that extend from the center portion of the spider plate. The blades can be directly attached to the arms of the spider (three blades are shown in FIG. 2). The blades can then be designed and/or angled to deliver the desired air or fluid circulation.

In these exemplary impellers, a hub is typically used to connect the base plate to the motor shaft. The hub typically comprises a metallic cylinder with an axial bore running through the center of the cylinder into which the motor shaft is secured. The hub is typically either manufactured and then attached to the base plate or formed integrally with the base plate. The hub typically has a threaded screw hole that extends from the outside of the cylinder through to the bore, running radially with respect to the bore. A set screw is inserted into the screw hole and, when tightened, engages the shaft perpendicularly to the shaft, typically creating two points of contact: a first point of contact between the inserted tip of the set screw and the shaft and a second point of contact between the shaft and the inside of the hub (on the bore wall opposite the set screw). One problem with a conventional hub described above is that the torque transfer capability from the shaft to the hub is limited by only having the above-mentioned two points of contact with the shaft. As a motor operates, it typically produces torque pulsations which are transferred to the shaft and therefore to the two points of contact between the hub and the shaft. High torque pulsations can cause the engagement at the two points of contact to begin relative micro movements. Eventually, this movement at the two points of contact generates fretting corrosion, noise and eventual failure of the connection between the hub and the shaft.

In an attempt to increase the torque transfer capability of hubs, modified hubs (e.g., see FIGS. 3A-3D) were used comprising two set screws to create three points of contact with the shaft. Referring now to FIGS. 3A-3D, the prior art modified hub (A) comprises a body (B) and a bore (“a hole made by or as if made by boring”) (C) that runs axially through the center of the body (B) of the hub (A). As illustrated in FIG. 3D, a first set screw (D) is threaded through a threaded set screw hole (E) that extends radially from the bore (C) through the body (B) of the hub (A). Similarly, a second set screw (F) is threaded through a second threaded set screw hole (G) that extends radially from the bore (C) through the body (B) of the hub (A). The second set screw hole (G) is offset from the first set screw hole (E) by about 90 degrees (some prior art modified hubs had two set screws that were offset by about 120 degrees). A shaft (not shown in FIGS. 3A-3D) can be inserted into the bore (B) of the hub (A) and secured to the hub (A) by sequentially tightening the two set screws (D, F). Using the modified hub (A), there are at least three points of contact with the shaft: contact between the shaft and each of the set screws (D, F) and contact between the shaft and the interior surface (H) of the body (B) located generally across the bore (C) from the two set screw holes (E, G).

Set screws tightened to retain a shaft in place often create a burr on the outer surface of the shaft. In the case of a shaft inside a relatively tight-fitting bore, a burr can prevent the shaft from being easily removed from the hub. Thus, each set screw hole (E, G) also preferably has an associated relief channel (J, K) that is normally cut into the hub. These channels (J, K) provide clearance so that even a shaft with a burr can readily be removed from the hub.

While the prior art two set screw hub shown in FIGS. 3A-3D does increase the torque transfer capability of the hub, the addition of a second set screw, a second set screw hole, and a second relief channel adds additional cost to the manufacture of the hub.

### SUMMARY OF THE INVENTION

According to the present invention, a hub is provided that allows improved torque transfer without requiring the addition of a second set screw, a second set screw hole, or a second relief channel.

The present invention is a hub for securing a shaft that provides three points of contact with the shaft. At a first level, the hut) of the present invention comprises a body having at least one opening into which the shaft is inserted, the body further comprising at least one set screw hole extending through at least a portion of the body into the opening, the set screw hole accepting a set screw that contacts the shaft when a portion of the set screw extends into the opening and a portion of the body that defines the opening having a contour generally opposite the set screw hole that provides at least two points of contact with the shaft, thereby providing at least three points of contact to secure the shaft inside the opening: one point of contact between the set screw and the shaft and the other two points of contact between the shaft and the body.

The hub of the present invention preferably includes a depression that provides at least two points of contact with the shaft, with one point of contact being provided at one side of the depression and the other point of contact being provided at another side of the depression. The depression is preferably a groove positioned generally opposite the set screw hole to provide at least two points of contact with the shaft, with one point of contact being provided at one side of the groove and the other point of contact being provided at another side of the groove.

At another level, the opening is preferably a bore and most preferably a fluted bore having a plurality of grooves positioned on a perimeter of the fluted bore so as to permit reaming of the fluted bore, with one of the grooves being positioned generally opposite the set screw hole to provide at least two points of contact with the shaft, with one point of contact being provided at one side of the one groove and the other point of contact being provided at another side of the one groove.

The present invention also includes various impellers using the hub of the present invention, such as a “squirrel cage” impeller with the hub of the present invention, and other classic hub applications with the hub of the present invention, such as a gear plate or a pulley using the hub of the present invention.

It is therefore an advantage of the present invention to provide a hub having increased torque transmission capability.

It is a further advantage of the present invention to provide a hub that contacts a shaft at at least three points.

It is a further advantage of the present invention to provide a very cost-effective hub that contacts a shaft at three points.

### BRIEF DESCRIPTION OF THE FIGURES

In the accompanying drawings, which are incorporated in and constitute a part of this specification, embodiments of the invention are illustrated, which, together with a general description of the invention given above, and the detailed description given below serve to illustrate the principles of this invention. The illustrated embodiments are not meant to limit the invention in such a way that simple modifications, such as those that could be made by one skilled in the art, are not also within the scope and spirit of the inventive concepts discussed and claimed herein.

FIG. 1 is a perspective view of a prior art “squirrel cage” impeller having a center base plate, a prior art hub, and a plurality of blades;

FIG. 2 is a perspective view of a prior art impeller having a spider base plate, a prior art hub, and a plurality of blades;

FIG. 3A is a perspective view of a prior art two set screw hub;

FIG. 3B is a top view (bore, view) of the prior art two set screw hub shown in FIG. 3A;

FIG. 3C is a section view of the prior art two set screw hub shown in FIGS. 3A and 3B taken along section line 3C-3C in FIG. 3B;

FIG. 3D is a top view (bore view) of the prior art two set screw hub shown in FIGS. 3A-3C showing the two set screws;

FIG. 4A is a perspective view of a hub according to the present invention;

FIG. 4B is a top view (bore view) of the hub according to the present invention shown in FIG. 4A;

FIG. 4C is a section view of the hub according to the present invention shown in FIGS. 4A and 4B taken along section line 4C-4C in FIG. 4B;

FIG. 4D is a top view (bore view) of the hub according to the present invention shown in FIGS. 4A-4C;

FIG. 4E is a section view (bore view) of the hub according to the present invention shown in FIGS. 4A-4D taken along section line 4E-4E in FIG. 4C;

FIG. 5A shows a side view of a portion of a “squirrel cage” impeller of the present invention having a center base plate, a hub according to the present invention, and a pair of exemplary blades; and

FIG. 5B shows a section view (bore view) of the impeller of the present invention taken along the section line 5B-5B in FIG. 5A.

### DETAILED DESCRIPTION

According to the present invention, a hub is provided that provides increased torque transmission capabilities, while not adding substantially to the cost of manufacturing the hub.

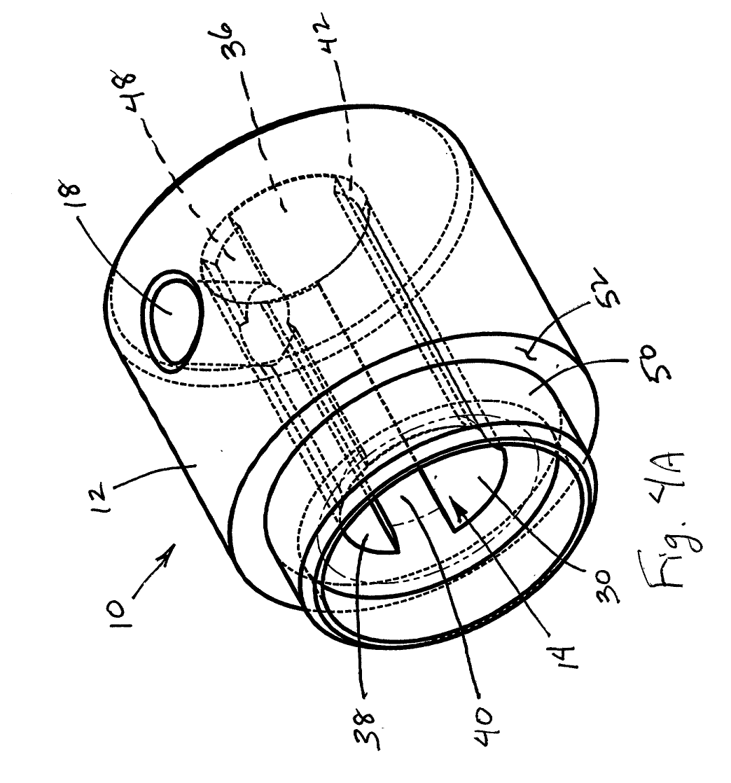

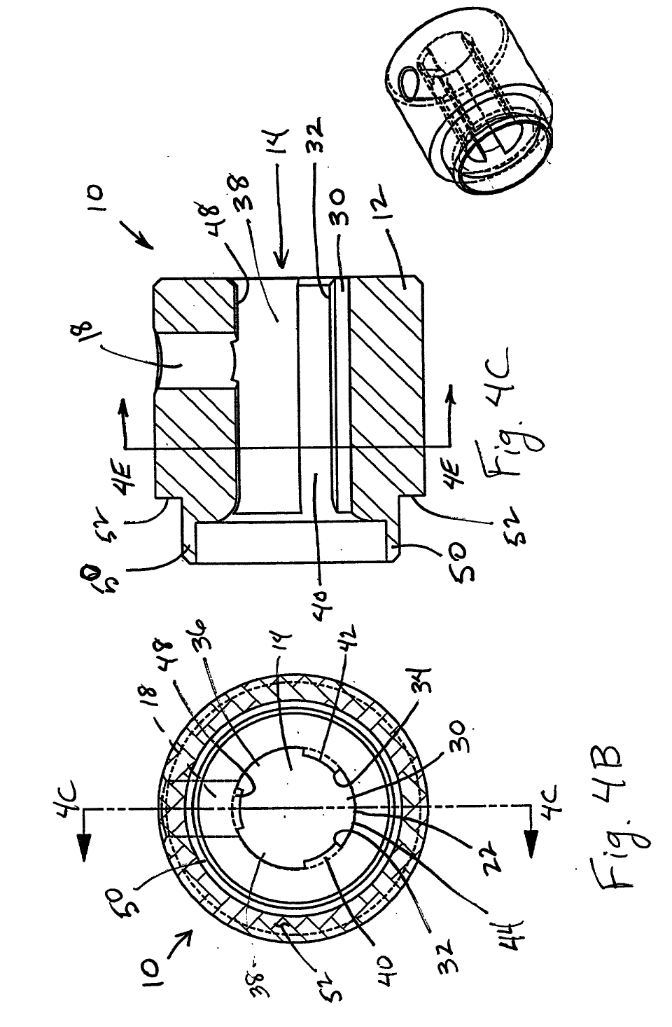

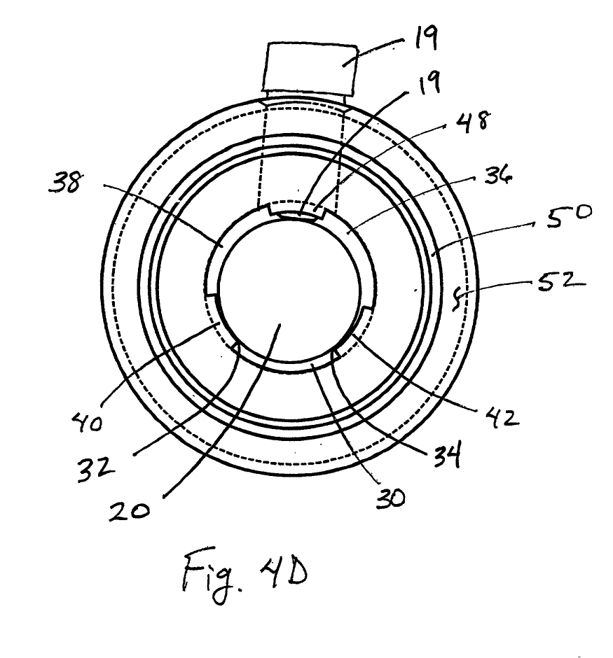

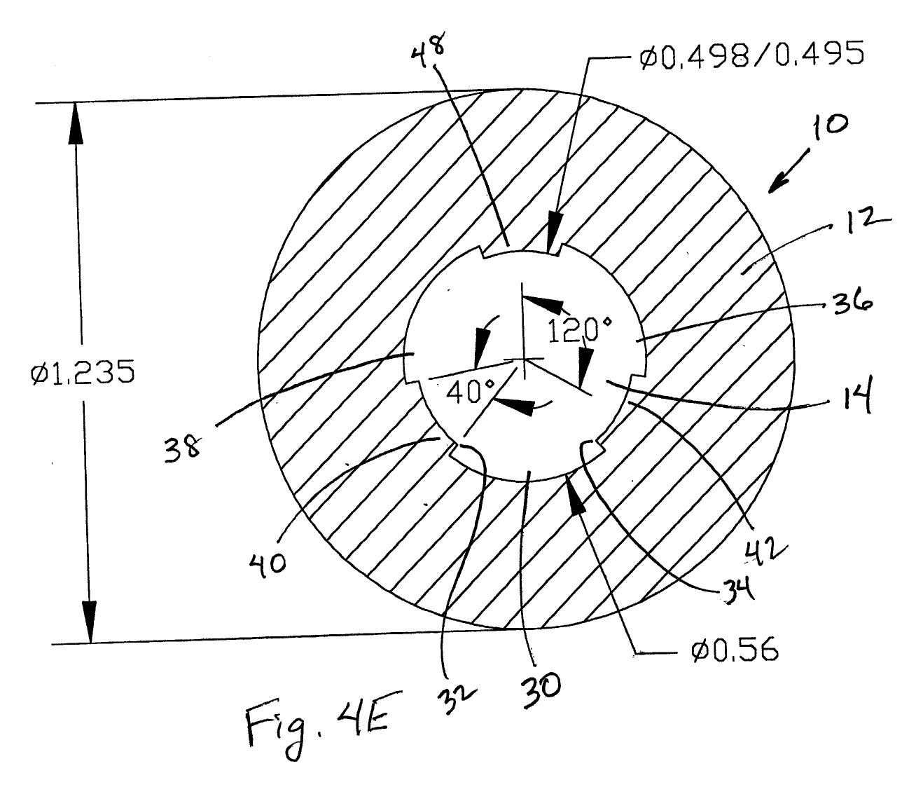

One embodiment 10 of the hub present invention is shown in FIGS. 4A-4E. Referring now to FIGS. 4A-4E, the inventive hub 10 comprises a body 12 having at least one bore 14 (or other opening) into which a shaft 20 is inserted. The body 12 is preferably cylindrical in shape, with the bore 14 running along the central axis of the cylinder. The body 12 can be made of any suitable material, such as AISI C1215 steel or AISI 12L14 steel. The body 12 also preferably includes at least one set screw hole 18 extending through at least a portion of the body 12 into the bore 14. The set screw hole 18 preferably extends radially with respect to the central axis of the bore 14, as shown in FIGS. 4A-4D. The set screw hole 18 accepts a set screw 19 that contacts the shaft 20 (FIG. 4D) when a portion of the set screw 19 extends into the bore 14.

In the hub according to the present invention, a portion of the body 12 that defines the bore 14 or other opening has a contour generally opposite the set screw hole 18 (preferably generally opposite the location where the set screw hole 18 enters the bore 14 or other opening) that provides at least two points of contact with the shaft 20, thereby providing at least three points of contact to secure the shaft 20 inside the bore 14 or other opening: one point of contact between the set screw 19 and the shaft 20 and the other two points of contact between the shaft 20 and the body 12.

More specifically with respect to the embodiment of the present invention shown in FIGS. 4A-4E, a portion of the body 12 that defines the bore 14 preferably has a groove 30 therein, positioned generally opposite (at 22) the set screw hole 18 to provide at least two points of contact 32, 34 with the shaft 20, with one point of contact 32 being provided at one side of the groove 30 and the other point of contact 34 being provided at another side of the groove 30. In the specific embodiment shown in FIGS. 4A-4E, the points of contact 32, 34 are line points of contact provided by the edges of groove 30 (see FIG. 4C). As described above, the two points of contact 32, 34 are provided by a groove 30, leaving two “lobes” or “lands” of material 40, 42 providing points of contact 32, 34. In the alternative, the two points of contact 32, 34 can be provided by (or at least thought of as being provided by) adding two lands 40, 42 to an inner portion 44 of body 12 generally opposite the set screw hole 18 thereby providing two points of contact 32, 34. Either way, the important aspect is providing a plurality of contact points with the body 12 and the shaft 20 generally opposite the set screw hole 18.

As described above, the hub 10 preferably comprises a body 12 with a bore 14 having a groove 30. More preferably, as shown in FIGS. 4A-4E, the bore 14 is a fluted bore 14 having a plurality of parallel grooves 30, 36, 38, with one of said parallel grooves being the groove 30 that provides at least two points of contact 32, 34 with the shaft 20. The plurality of grooves 30, 36, 38 are preferably three grooves 30, 36, 38 that define three lands 40, 42, 48 that define the space where the shaft 20 is held. These three lands 40, 42, 48 are preferably arc-shaped in the area defining the space where the shaft 20 is held. The plurality of lands 40, 42, 48 are preferably spaced so that they can be reamed; the lands 40, 42, 48 are thus preferably equally, symmetrically spaced around the perimeter of the bore 14. As viewed from FIG. 4C, the lands 40, 42, 48 appear as ridges.

FIG. 4E shows one possible arrangement of the plurality of grooves 30, 36, 38 and the plurality of lands 40, 42, 48 for a shaft 20 that is nominally 0.500 inches in radius (typically ranging between 0.495 inches and 0.500 inches in radius, with most of the shafts being at about the midpoint of that range). As can be seen, the grooves 30, 36, 38 have an inside radius of about 0.560 inches and the lands 40, 42, 48 have an inside radius in the range of about 0.498 inches to about 0.495 inches. The lands 40, 42, 48 in this particular arrangement define arcuate portions of about 40 degrees (grooves 30, 36, 38 of about 80 degrees) and their centers are spaced at about 120 degrees with respect to each other. Numerous other arrangements are possible; it would appear to be preferable to have a groove 30 or grooves 30, 36, 38 of from about 30 degrees to about 120 degrees, centered across from the center of the set screw hole 18. That said, a groove or grooves outside this angular range may well appropriate the benefits of the present invention. The radius for the shaft space (the parameter having a value range of 0.498 inches to 0.495 inches in FIG. 4E) can be nominally less than the nominal radius of the shaft 20 because a portion of the shaft 20 is expected to extend slightly into the groove 30 (to provide the two points of contact 32, 34), which can provide additional clearance with respect to land 48. In the alternative, the radius for the shaft space can be about the same size or larger than the nominal radius of the shaft 20. The difference in radius between the lands 40, 42, 48 and the grooves 30, 36, 38 in this example is large enough that the bore 14 ought to be bored slightly off the central axis of the cylindrical body 12 (in this case the central axis of the body 12 defines the alignment with a base plate or gear plate). The difference in radius between the lands 40, 42, 48 and the grooves 30, 36, 38 need not be as large as in this example. This difference can be about 0.015 inches (or virtually any other value large enough that the shaft 20 does not bottom-out in the bottom of groove 30 or, if there are three grooves, the bottom of grooves 30, 36, 38), and the bore 14 can be centered in the body 12. The lands 40, 42, 48 and the grooves 30, 36, 38 preferably extend substantially the entire length of the bore 14.

The hub 10 according to the present invention can be manufactured by cold forging, e.g., using a cold heading machine having a plurality of stages, as known to those skilled in the art. Rather that using a circular pin to form a circular bore (as with prior art hubs), to form the hub 10 of the present invention, the cold heading machine uses a fluted pin to form the fluted bore 14 having lands 40, 42, 48 and grooves 30, 36, 38. In the alternative, one groove (e.g., groove 30) or a plurality of grooves (e.g., grooves 30, 36, 38) can be added (e.g., by milling or broaching) as a secondary operation to a hub having a circular bore. Either way, the threaded set screw hole 18 is then added and the hub is preferably reamed to the proper size.

The hub 10 of the present invention is either made integrally with a base plate or manufactured separately and then affixed to the base plate. If manufactured separately and then affixed thereto, the hub 10 is preferably swedged to the base plate. Toward this end, the hub 10 preferably has a roll-over lip 50 located adjacent to a knurled surface 52 the hub body 12. As with prior art hubs, the roll-over lip 50 is for insertion into a correspondingly-sized hole in the center of a base plate (or a gear plate or a pulley, not shown). During assembly, the roll-over lip 50 is inserted into the hole in the base plate and then swedged to the base plate by rolling the rollover lip 50 over so that the base plate is secured between the folded over rollover lip 50 and the surface 52 of hub 10.

A shaft 20 is secured to a hub 10 of the present invention by inserting the shaft 20 far enough that it at least overlaps the location where the set screw hole 18 opens into the bore 14, threading a set screw 19 into the set screw hole 18 until it contacts the shaft 20, aligning the shaft 20 with the plurality of points of contact (if necessary) (the configuration shown in FIGS. 4A-4E is self-aligning) and tightening the set screw 19 against shaft 20 to secure shaft 20 between the set screw 19 and the multiple points of contact on the inside of bore 14 (e.g., points of contact 32, 34).

The preferred embodiment of the hub of the present invention does not include any relief channels (J, K) shown in the context of the prior art hub (A). In the embodiment shown in FIGS. 4A-4E, grooves 30, 36, 38 allow for an increase tolerance fit between the shaft 20 and the bore 14 when the set screw 19 is loose, thereby allowing the hub to be easily removed from the motor shaft without a relief channel, even with a burr on the shaft caused by the set screw 19. Hubs of different configurations, e.g., a hub with 0.015 inches difference between lands and grooves, might have such a tight tolerance between the shaft 20 and the lands that adding some form of relief channel adjacent the set screw hole 18 might be advantageous. Such a relief channel could be formed in the bore 14 by having a land on one side or a land on either side of set screw hole 18 (not shown). Additionally, in most applications, the motor shaft has a flat which is oriented toward the set screw before engagement and the burr generated by the set screw is not an issue in this case.

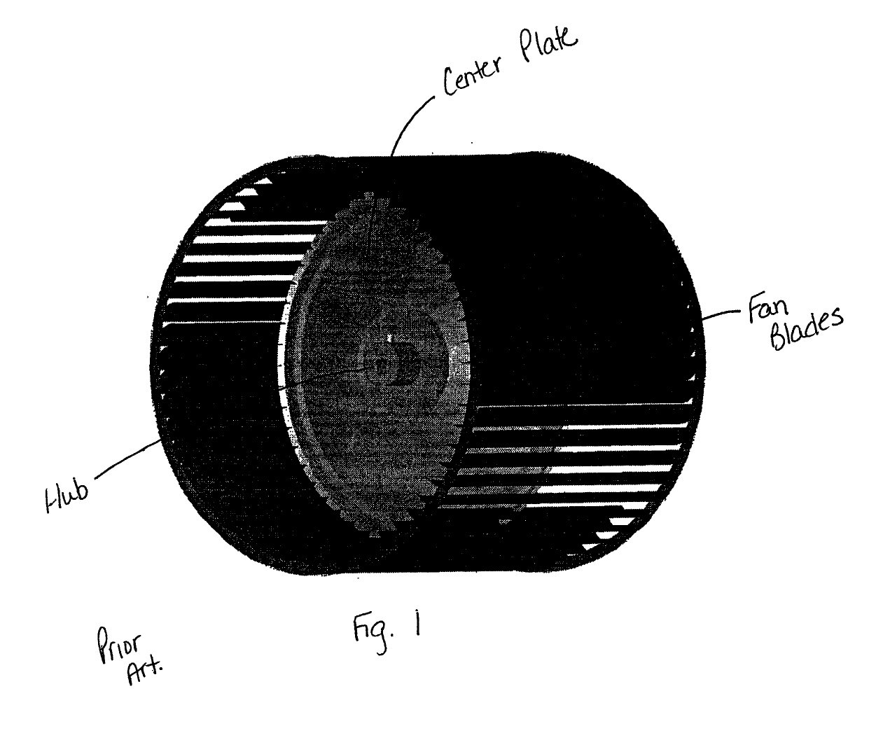

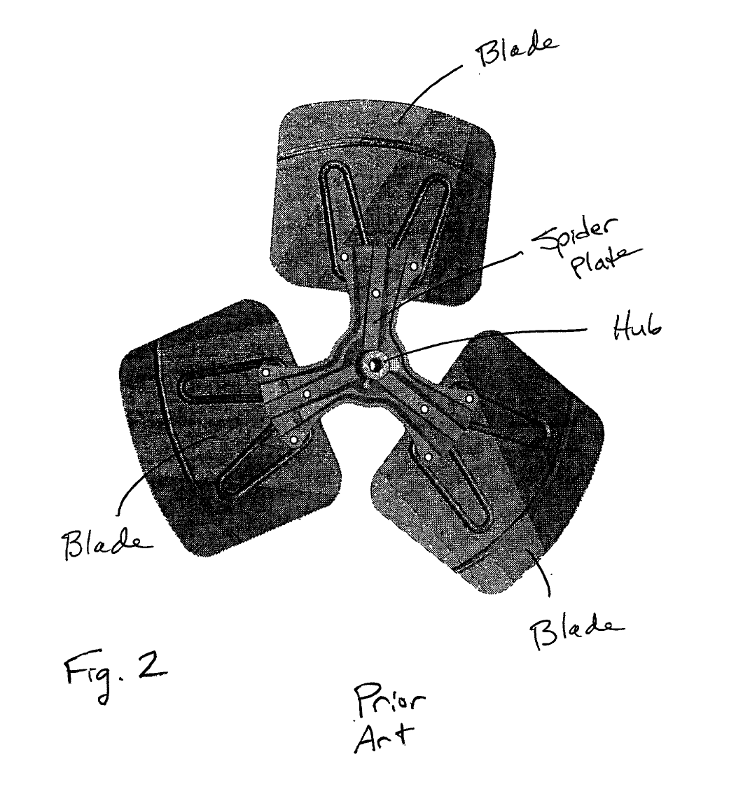

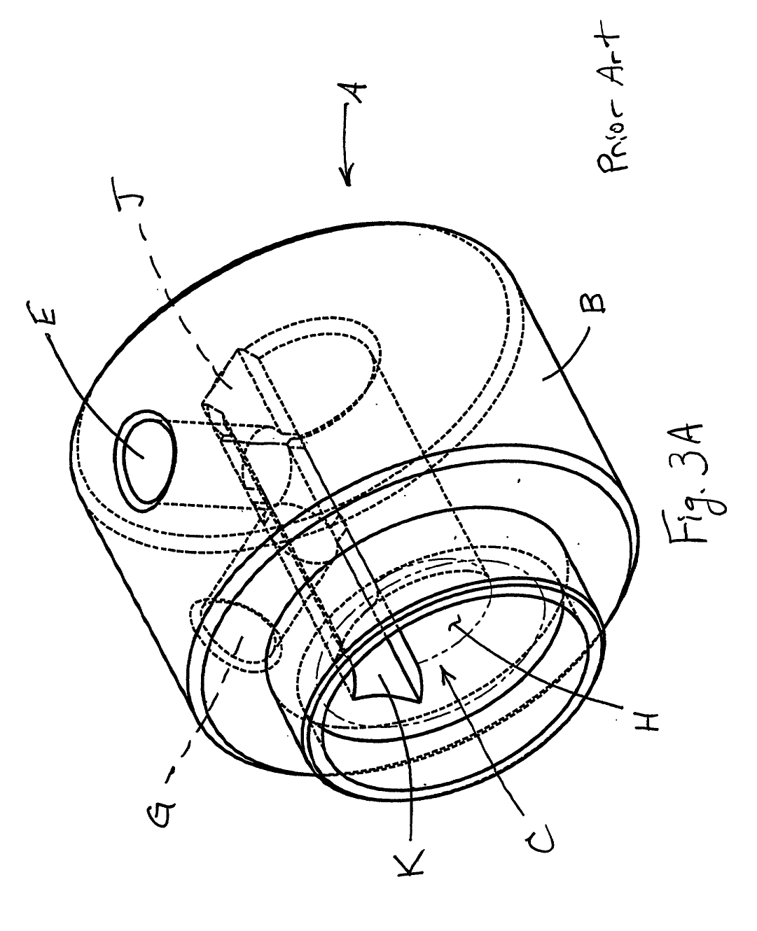

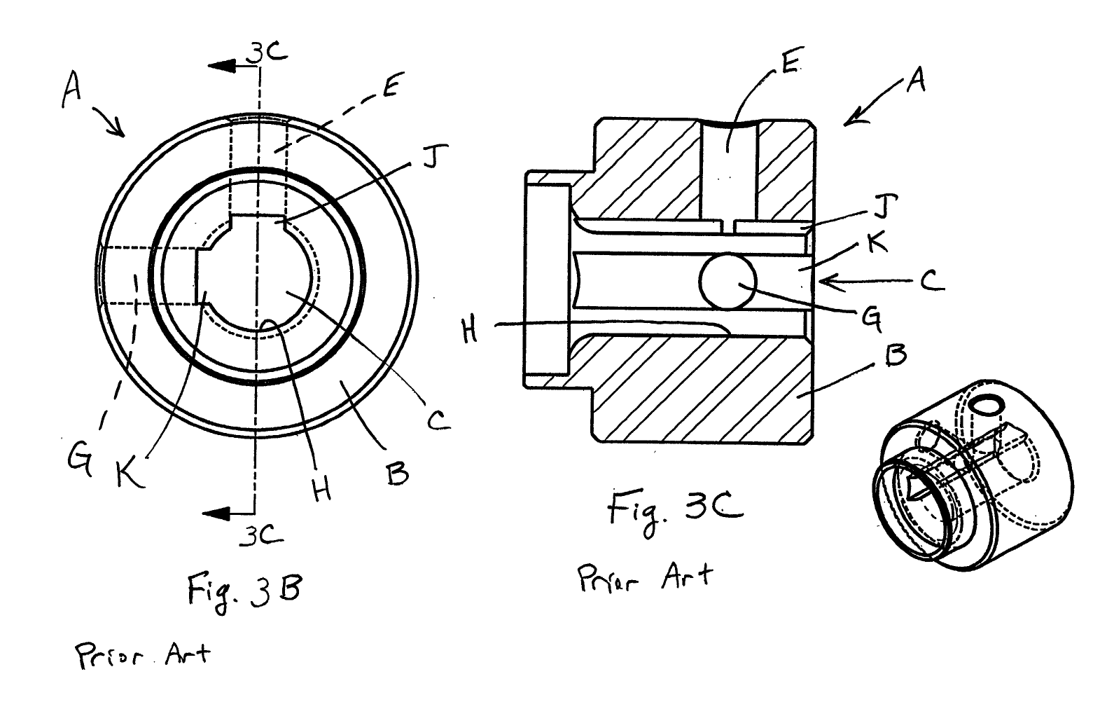

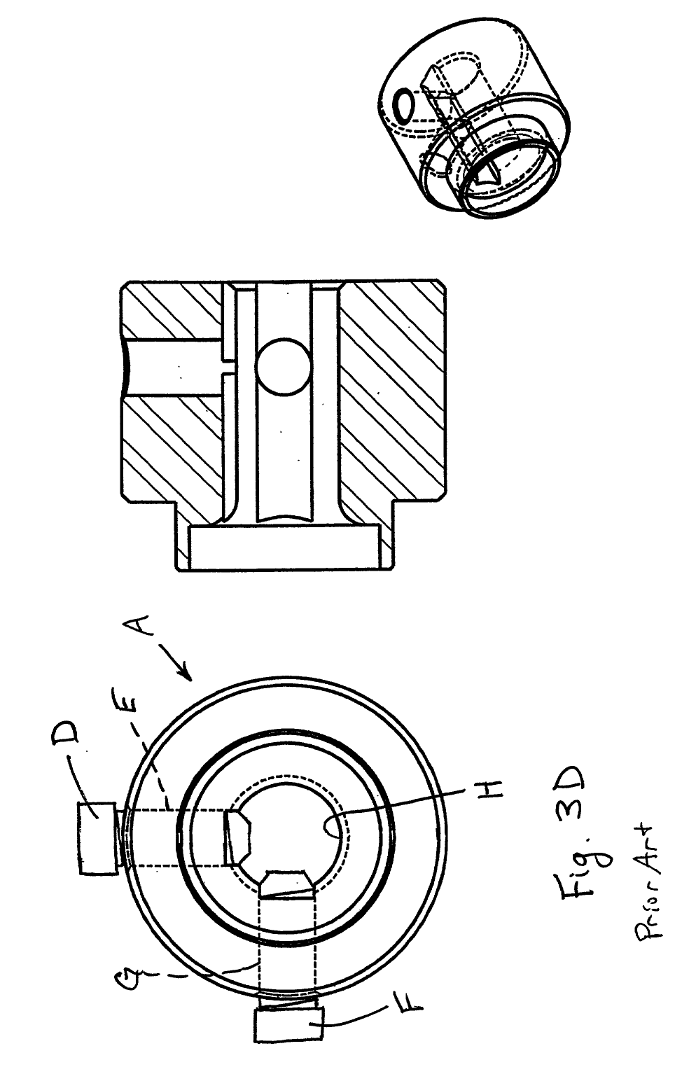

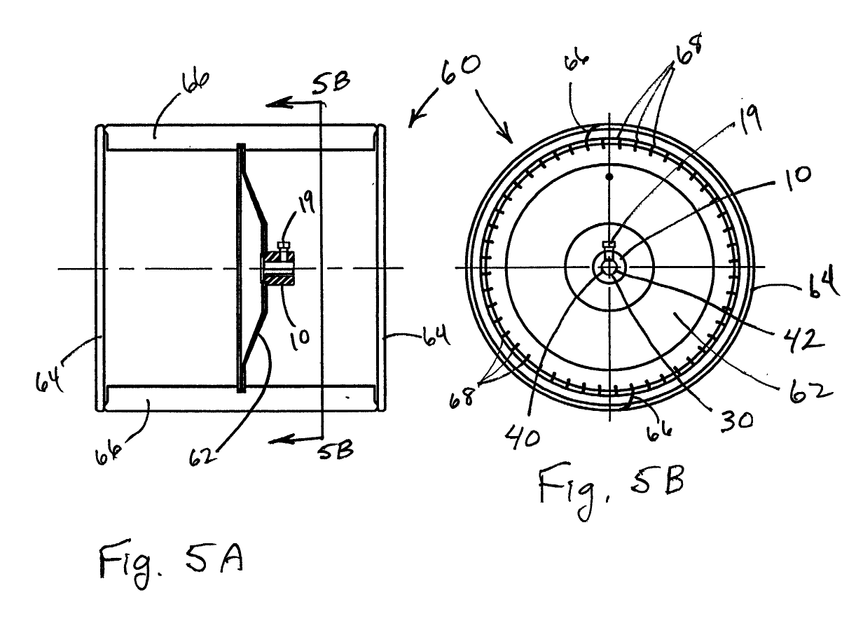

The teachings of the present invention can be used to modify virtually any prior art hub. Additionally, the hub of the present invention can replace virtually any prior art hub (of course additional changes to some dimensions and some structures, e.g., rollover lip 50, might be necessary). FIGS. 5A and 5B show a squirrel cage type impeller 60 of the type shown in FIG. 1 modified to use the hub 10 of the present invention. The impeller 60 comprises a base plate 62 (a center plate), a hub 10 according to the present invention swedged onto one side of the base plate 62, two support rims 64, and blades 66 (only two blades 66 are shown for clarity). The base plate 62 has a plurality of openings 68 into which the respective blades 66 are secured using means known to those skilled in the art. Similarly, the impeller of FIG. 2 can also be modified to use the hub 10 according to the present invention. In that case, the hub 10 would be swedged onto the spider base plate to which the blades are secured.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. For example, the grooves 30, 36, 38 are shown as being arc-shaped; in the alternative, they can be shaped in virtually any number of ways so as to provide multiple points of contact with the shaft, e.g., cut flat like relief channels (J, K). Similarly, the lands 40, 42, 48 are shown as lands being concave arc-shaped in cross-section; in the alternative, they can be shaped in virtually any number of ways so as to provide multiple points of contact with the shaft, e.g., convex lands or even asymmetrical lands. As another example, the grooves 30, 36, 38 are shown as being formed in such a manner so that there appears to be a step transition between lands and adjacent grooves; in the alternative, the lands transition in virtually any fashion into adjacent grooves, e.g., lands can smoothly taper into adjacent grooves and/or lands can have a rounded step to adjacent grooves. As yet another example, the hub of the present invention is shown as being used with impellers; in the alternative, the benefits of the hub of the present invention can be utilized in other hub applications, e.g., hubs for gears and hubs for pulleys. Also, the lands 40, 42, 48 are shown as being continuous ridges of material; in the alternative, they can be discontinuous., e.g., a plurality of bumps or shorter ridges. Of course, the hub body 12 and bore 14 need not be substantially cylindrical or even symmetrical. Therefore, the invention in its broader aspects is not limited to the specific details, representative apparatuses, and illustrative figures shown and described. Accordingly, departures may be made from such details without departing from the spirit or scope of the applicant's general inventive concept.

What is claimed is:

1. A hub for securing a shaft, said hub comprising:
a body having at least one opening into which the shaft is inserted;
said body further comprising at least one set screw hole extending through at least a portion of said body into said opening;
said set screw hole accepting a set screw that contacts the shaft when a portion of the set screw extends into said opening; and
a portion of said body that defines said opening having a contour generally opposite said set screw hole that provides at least two points of contact with the shaft, thereby providing at least three points of contact to secure the shaft inside said opening: one point of contact between the set screw and the shaft and the other two points of contact between the shaft and said body.

2. The hub according to claim 1 wherein said portion of said body having a contour providing at least two points of contact with the shaft comprises a portion of said body having a depression therein, positioned generally opposite said set screw hole to provide at least two points of contact with the shaft, with one point of contact being provided at one side of said depression and the other point of contact being provided at another side of said depression.

3. The hub according to claim 1 wherein said portion of said body having a contour providing at least two points of contact with the shaft comprises a portion of said body having a groove therein, positioned generally opposite said set screw hole to provide at least two points of contact with the shaft, with one point of contact being provided at one side of said groove and the other point of contact being provided at another side of said groove.

4. A hub for securing a shaft, said hub comprising:
a body having a bore into which the shaft is inserted;
said body further comprising at least one set screw hole extending through at least a portion of said body into said bore;
said set screw hole accepting a set screw that contacts the shaft when a portion of the set screw extends into said bore; and
a portion of said body that defines said bore having a groove therein, positioned generally opposite said set screw hole to provide at least two points of contact with the shaft, with one point of contact being provided at one side of said groove and the other point of contact being provided at another side of said groove;
thereby providing at least three points of contact to secure the shaft inside said bore: one point of contact between the set screw and the shaft and the other two points of contact between the shaft and said body.

5. The hub according to claim 4 wherein said bore is a fluted bore having a plurality of parallel grooves, with one of said parallel grooves being said groove providing at least two points of contact with the shaft.

6. A hub for securing a shaft, said hub comprising:
a body having a fluted bore into which the shaft is inserted;
said body further comprising at least one set screw hole extending through at least a portion of said body into said fluted bore;
said set screw hole accepting a set screw that contacts the shaft when a portion of the set screw extends into said fluted bore; and
said fluted bore has a plurality of grooves positioned on a perimeter of said fluted bore so as to permit reaming of said fluted bore, one of said grooves being positioned generally opposite said set screw hole to provide at least two points of contact with the shaft, with one point of contact being provided at one side of said one groove and the other point of contact being provided at another side of said one groove;
thereby providing at least three points of contact to secure the shaft inside said fluted bore: one point of contact between the set screw and the shaft and the other two points of contact between the shaft and said body.

7. The hub according to claim 6 wherein said grooves of said fluted bore are symmetrically arranged around said perimeter of said fluted bore.

8. The hub according to claim 6 wherein said fluted bore has three grooves and wherein said three grooves of said fluted bore are symmetrically arranged around said perimeter of said fluted bore.

9. An impeller having a base plate affixed to a hub for securing a shaft, said hub comprising:
a body having a fluted bore into which the shaft is inserted;
said body further comprising at least one set screw hole extending through at least a portion of said body into said fluted bore;
said set screw hole accepting a set screw that contacts the shaft when a portion of the set screw extends into said fluted bore; and
said fluted bore has a plurality of grooves positioned on a perimeter of said fluted bore so as to permit reaming of said fluted bore, one of said grooves being positioned generally opposite said set screw hole to provide at least two points of contact with the shaft, with one point of contact being provided at one side of said one groove and the other point of contact being provided at another side of said one groove;
thereby providing at least three points of contact to secure the shaft inside said fluted bore: one point of contact between the set screw and the shaft and the other two points of contact between the shaft and said body.

10. The impeller according to claim 9 wherein said base plate affixed to said hub is a center plate carrying a plurality of blades forming a squirrel cage type impeller.

11. The impeller according to claim 9 wherein said base plate affixed to said hub is a spider plate carrying a plurality of blades.

12. A gear plate affixed to a hub for securing a shaft, said hub comprising:
a body having a fluted bore into which the shaft is inserted;
said body further comprising at least one set screw hole extending through at least a portion of said body into said fluted bore;
said set screw hole accepting a set screw that contacts the shaft when a portion of the set screw extends into said fluted bore; and
said fluted bore has a plurality of grooves positioned on a perimeter of said fluted bore so as to permit reaming of said fluted bore, one of said grooves being positioned generally opposite said set screw hole to provide at least two points of contact with the shaft, with one point of contact being provided at one side of said one groove and the other point of contact being provided at another side of said one groove;
thereby providing at least three points of contact to secure the shaft inside said fluted bore: one point of contact between the set screw and the shaft and the other two points of contact between the shaft and said body.

13. A pulley affixed to a hub for securing a shaft, said hub comprising:
a body having a fluted bore into which the shaft is inserted;
said body further comprising at least one set screw hole extending through at least a portion of said body into said fluted bore;
said set screw hole accepting a set screw that contacts the shaft when a portion of the set screw extends into said fluted bore; and
said fluted bore has a plurality of grooves positioned on a perimeter of said fluted bore so as to permit reaming of said fluted bore, one of said grooves being positioned generally opposite said set screw hole to provide at least two points of contact with the shaft, with one point of contact being provided at one side of said one groove and the other point of contact being provided at another side of said one groove;
thereby providing at least three points of contact to secure the shaft inside said fluted bore: one point of contact between the set screw and the shaft and the other two points of contact between the shaft and said body.
